(19) United States
(12) Patent Application Publication
(10) Pub. No.: US 2025/0030316 A1
(43) Pub. Date: Jan. 23, 2025

(54) ELECTRIC GENERATOR SYSTEM

(71) Applicant: BorgWarner Inc., Auburn Hills, MI (US)

(72) Inventors: John Robert Zagone, Hendersonville, NC (US); Michal Zatek, Zbyslavice (CZ); Piotr Jaworski, Glogow Malopolski (PL)

(21) Appl. No.: 18/777,091

(22) Filed: Jul. 18, 2024

Related U.S. Application Data
(60) Provisional application No. 63/527,662, filed on Jul. 19, 2023.

(51) Int. Cl. H02K 7/18; H02K 7/00; H02K 9/14

(52) U.S. Cl. CPC H02K 7/183; H02K 7/003; H02K 9/14

(57) ABSTRACT

An electric generator system includes a rotating detonation combustor having an outer wall, an inner wall, and a combustion chamber configured to receive a fuel and an oxidizing agent and expel exhaust gas. The electric generator system also includes a first turbine wheel in fluid communication with the combustion chamber and configured to rotate upon receiving the exhaust gas, a shaft rotatable with the first turbine wheel, and a compressor wheel rotatable with the shaft, in fluid communication with the combustion chamber, and configured to deliver compressed oxidizing agent to the combustion chamber. The electric generator system further includes a second turbine wheel in fluid communication with the first turbine wheel and configured to rotate upon receiving the exhaust gas from the first turbine wheel, and an electric generator rotatable with the second turbine wheel and configured to convert rotational motion of the second turbine wheel to electrical energy.

### CROSS-REFERENCE TO RELATED APPLICATIONS

This application claims priority to and all the benefits of U.S. Provisional Application No. 63/527,662, filed Jul. 19, 2023, which is hereby incorporated by reference in its entirety.

### BACKGROUND OF THE INVENTION

### 1. Field of the Invention

The invention generally relates to an electric generator system.

### 2. Description of the Related Art

Systems commonly convert chemical energy in fuel to electrical energy. The systems typically include an internal combustion engine defining a combustion chamber for receiving a mixture of fuel and air. The mixture of fuel and air is combusted in the combustion chamber at sub-sonic speeds in a process commonly known as deflagration. The combustion of the fuel and air generates hot exhaust gas which is then expelled from the combustion chamber and directed toward a turbine generator. The turbine generator typically includes a turbine wheel coupled to an electric generator through a shaft. The exhaust gas from the combustion chamber rotates the turbine wheel and the shaft, and the electric generator converts the rotational motion of the turbine wheel and shaft to electrical energy.

However, internal combustion engines are often inefficient in converting chemical energy in fuel to electrical energy. More specifically, internal combustion engines are thermodynamically limited to the efficiencies of the Brayton Cycle (e.g. combustion at near constant pressure) and thus have mechanical, thermal, and thermodynamic energy losses which directly affect the efficiency of converting chemical energy in fuel to electrical energy.

As such, there remains a need for an improved system for converting chemical energy in fuel to electrical energy.

### SUMMARY OF THE INVENTION AND ADVANTAGES

An electric generator system for converting rotational motion to electrical energy includes a rotating detonation combustor extending along an axis. The rotating detonation combustor has an outer wall extending along and circumferentially about the axis and has an inner wall extending along and circumferentially about the axis. The inner wall is spaced radially inward relative to the outer wall such that a combustion chamber is defined between the outer wall and the inner wall. The rotating detonation combustor is configured to receive a fuel and an oxidizing agent into the combustion chamber and expel exhaust gas from the combustion chamber.

The electric generator system also includes a first turbine wheel in fluid communication with the combustion chamber. The first turbine wheel is configured to rotate upon receiving the exhaust gas. The electric generator system further includes a shaft rotatable with the first turbine wheel and a compressor wheel rotatable with the shaft. The compressor wheel is in fluid communication with the combustion chamber and is configured to deliver compressed oxidizing agent to the combustion chamber. The electric generator system further includes a second turbine wheel in fluid communication with the first turbine wheel and configured to rotate upon receiving the exhaust gas from the first turbine wheel. The electric generator system further includes an electric generator rotatable with the second turbine wheel. The electric generator is configured to convert rotational motion of the second turbine wheel to electrical energy.

Accordingly, the electric generator system is able to convert chemical energy in fuel to electrical energy through combustion of the fuel in the rotating detonation combustor, through expulsion of the exhaust gas to rotate the second turbine wheel, and through conversion of the rotational motion of the second turbine wheel to electrical energy by the electric generator. Moreover, expulsion of the exhaust gas to rotate the first turbine wheel also rotates the shaft and the compressor wheel. As such, the compressor wheel is able to supply the combustion chamber with an adequate flow rate and pressure of the oxidizing agent.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic illustration of an electric generator system including a rotating detonation combustor, a compressor wheel, a first turbine wheel, a second turbine wheel, and an electric generator rotatable with the second turbine wheel;

FIG. 2 is a schematic illustration of the electric generator system including a heat recuperator fluidly disposed between the compressor wheel and the rotating detonation combustor such that the heat recuperator is configured to receive compressed oxidizing agent and directly heat the compressed oxidizing agent;

FIG. 3 is a schematic illustration of the electric generator system including the heat recuperator, an outlet heat exchange channel configured to include an outlet fluid, and a heat exchanger configured to receive compressed oxidizing agent from the compressor and direct heated, compressed oxidizing agent to the rotating detonation combustor;

FIG. 4 is a schematic illustration of the electric generator system including the heat recuperator, the outlet heat exchange channel, the heat exchanger, and an inlet heat exchange channel configured to include an inlet fluid capable of being heated by the rotating detonation combustor and configured to direct heated inlet fluid to the heat recuperator;

FIG. 5 is a schematic illustration of the electric generator system including a waste heat recovery unit configured to receive exhaust gas and recover heat from the exhaust gas; and

FIG. 6 is a cut-away perspective view of the rotating detonation combustor.

### DETAILED DESCRIPTION OF THE INVENTION

With reference to the Figures, wherein like numerals indicate like parts throughout the several views, an electric generator system 10 for converting rotational motion to electrical energy is provided. The electric generator system 10 includes a rotating detonation combustor 12 extending along an axis A1. The rotating detonation combustor 12 has an outer wall 14 extending along and circumferentially about the axis A1 and has an inner wall 16 extending along and circumferentially about the axis A1. The inner wall 16 is spaced radially inward relative to the outer wall 14 such that a combustion chamber 18 is defined between the outer wall 14 and the inner wall 16. The rotating detonation combustor 12 is configured to receive a fuel and an oxidizing agent into the combustion chamber 18 and expel exhaust gas from the combustion chamber 18. It is to be appreciated that the outer wall 14 and the inner wall 16 typically do not move, such as by rotation relative to one another. Moreover, the rotating detonation combustor 12 typically has little to no moving components.

The electric generator system 10 also includes a first turbine wheel 20 in fluid communication with the combustion chamber 18. The first turbine wheel 20 is configured to rotate upon receiving the exhaust gas. The electric generator system 10 further includes a shaft 22 rotatable with the first turbine wheel 20 and a compressor wheel 24 rotatable with the shaft 22. The compressor wheel 24 is in fluid communication with the combustion chamber 18 and is configured to deliver compressed oxidizing agent to the combustion chamber 18. The electric generator system 10 further includes a second turbine wheel 26 in fluid communication with the first turbine wheel 20 and configured to rotate upon receiving the exhaust gas from the first turbine wheel 20. The electric generator system 10 further includes an electric generator 28 rotatable with the second turbine wheel 26. The electric generator 28 is configured to convert rotational motion of the second turbine wheel 26 to electrical energy.

Accordingly, the electric generator system 10 can convert chemical energy in fuel to electrical energy through combustion of the fuel in the rotating detonation combustor 12, through expulsion of the exhaust gas to rotate the second turbine wheel 26, and through conversion of the rotational motion of the second turbine wheel 26 to electrical energy by the electric generator 28. Moreover, expulsion of the exhaust gas to rotate the first turbine wheel 20 also rotates the shaft 22 and the compressor wheel 24. As such, the compressor wheel 24 is able to supply the combustion chamber 18 with an adequate flow rate and pressure of the oxidizing agent.

Although not required, the electric generator system 10 may further include an electric machine 30 rotatable with the shaft 22. The electric machine 30 is configured to convert at least one of rotational motion of the shaft 22 to electrical energy, and electrical energy to rotational motion of the shaft 22. Accordingly, in the embodiments with the electric machine 30 rotatable with the shaft 22, the electric generator system 10 may be able to convert chemical energy in fuel to electrical energy through combustion of the fuel in the rotating detonation combustor 12, through expulsion of the exhaust gas to rotate the first turbine wheel 20 and the shaft 22, and through conversion of the rotational motion of the shaft 22 to electrical energy by the electric machine 30. Moreover, the electric machine 30 may be able to use electrical energy to rotate the shaft 22, and thus also rotate the compressor wheel 24, ensuring that an adequate flow rate and pressure of the oxidizing agent is delivered by the compressor wheel 24 to the combustion chamber 18. Ensuring adequate flow rate and pressure of the oxidizing agent to the combustion chamber 18 through use of the electric machine 30 is advantageous during periods of operation of the rotating detonation combustor 12 when the flow of exhaust gas to the first turbine wheel 20 cannot alone rotate the compressor wheel 24 with sufficient force to supply the combustion chamber 18 with an adequate flow rate and pressure of the oxidizing agent, such as during start-up of the rotating detonation combustor 12.

In one embodiment, the electric generator 28 is further defined as a first electric generator 28, and the electric machine 30 is further defined as a second electric generator 32 configured to only convert rotational motion of the shaft 22 to electrical energy. In another embodiment, the electric machine 30 is further defined as an electric motor 34 configured to only convert electrical energy to rotational motion of the shaft 22. However, the electric machine 30 may selectively function as both the second electric generator 32 and the electric motor 34. The electric machine 30 may be configured to both convert rotational motion of the shaft 22 to electrical energy, and convert electrical energy to rotational motion of the shaft 22.

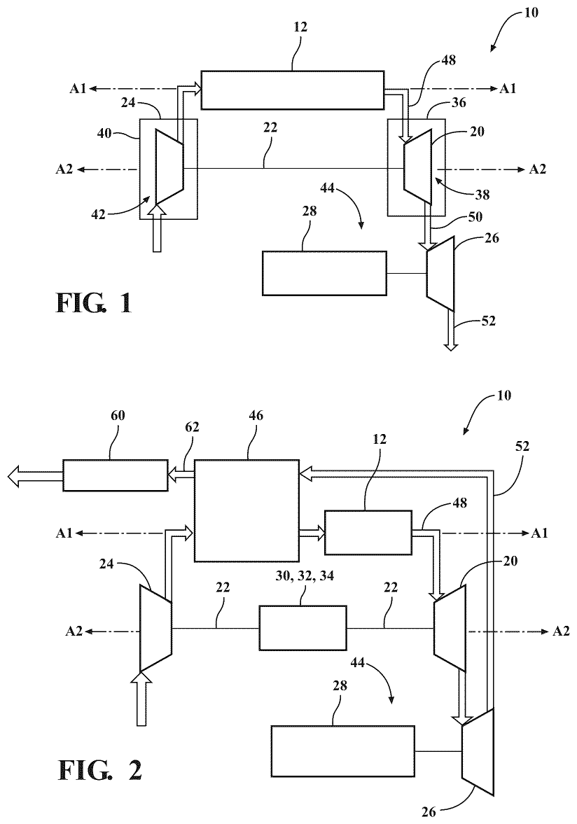

Although not required, in one embodiment as shown in FIG. 1, the shaft 22 extends along a second axis A2 different from the axis A1 along which the rotating detonation combustor 12 extends. As such, it is to be appreciated that the axis A1 may be further defined as a first axis A1. The electric generator system 10 may also further include a turbine volute housing 36 defining a turbine volute interior 38 and a compressor volute housing 40 defining a compressor volute interior 42. The turbine volute housing 36 may be a single volute turbine housing, a dual volute turbine housing, or a twin scroll turbine housing, as non-limiting examples. Moreover, the first turbine wheel 20 may be disposed in the turbine volute interior 38 and the compressor wheel 24 may be disposed in the compressor volute interior 42. Additionally, the electric generator system 10 may include one or more additional housings, such as a bearing housing, fixed between the turbine volute housing 36 and the compressor volute housing 40.

The compressor wheel 24, the compressor volute housing 40, the shaft 22, the first turbine wheel 20, and the turbine volute housing 36 may together form a turbocharger. The electric machine 30 may be co-axial with the second axis A2, thus forming an electric turbocharger, which is also known as an e-turbocharger or an e-turbo. The electric machine 30 may be disposed between the first turbine wheel 20 and the compressor wheel 24, and may be both co-axial with the second axis A2 and disposed between the compressor wheel 24 and the first turbine wheel 20 in the electric turbocharger. The turbocharger, whether in the form of an electric turbocharger or otherwise, does not require a wastegate or a variable turbine geometry (VTG) assembly, although the turbocharger may include a wastegate or a variable turbine geometry (VTG) assembly.

The electric machine 30 may be configured to control a mass flow rate of the oxidizing agent to the rotating detonation combustor 12. The electric machine 30 may control the mass flow rate of oxidizing agent to the rotating detonation combustor 12 by converting electrical energy to rotational motion of the shaft 22, thus increasing the mass flow rate of oxidizing agent to the rotating detonation combustor 12, or by converting rotational motion of the shaft 22 to electrical energy, thus decreasing the mass flow rate of oxidizing agent to the rotating detonation combustor 12. The electric machine 30 may be configured to control the mass flow rate of the oxidizing agent to the rotating detonation combustor 12 such that the rotating detonation combustor 12 operates with a lean fuel to oxidizing agent ratio.

In a non-limiting example, the fuel that the rotating detonation combustor 12 is configured to receive is hydrogen gas. Hydrogen gas advantageously produces no carbon dioxide emissions. However, it is to be appreciated that the rotating detonation combustor 12 is flexible in which type of fuel it may receive, including but not limited to hydrocarbon-based fuels, gasoline, kerosene, natural gas, and jet fuel. In a non-limiting example, the oxidizing agent that the rotating detonation combustor 12 is configured to receive is air. However, it is to be appreciated that the rotating detonation combustor 12 is flexible in which type of oxidizing agent it receives, including but not limited to pure oxygen and a mixture of air and pure oxygen such that the mixture has a greater relative concentration of oxygen as compared to air.

Although not required, the fuel and the oxidizing agent may be combusted under lean conditions. Combustion in the combustion chamber 18 generates significant heat, particularly because the rotating detonation combustor 12 is highly efficient. However, combusting the fuel and the oxidizing agent under lean conditions mitigates the rate at which heat is generated and thus assists in maintaining the temperature of the electric generator system 10 and the exhaust gas within acceptable and safe limits. Moreover, combusting the fuel and the oxidizing agent under lean conditions improves the specific fuel consumption (SFC) and lowers or reduces nitrogen oxide (NOx) emissions.

Moreover, the fuel may be combusted in a detonation. More specifically, the fuel and the oxidizing agent may be combusted in a detonation wave which propagates at supersonic speed continuously around the combustion chamber 18. It is to be appreciated that the combustion chamber 18 may be defined to be annular, and thus the detonation wave may propagate along an annular path. Said differently, the combustion chamber 18 may be defined as a ring in cross-section, and the detonation wave may appear to “spin” radially about the ring of the combustion chamber 18. The detonation wave may be initiated by an ignition process. It is to be appreciated that the oxidizing agent, the fuel, and the exhaust gas also may travel along the annular path, but also travel along the axis A1.

Detonation results in greater efficiency of combustion as compared to deflagration, and, as such, the rotating detonation combustor 12 has increased thermodynamic efficiencies. More specifically, the thermodynamic efficiencies of the rotating detonation combustor 12 may be described by the Fickett-Jacobs Cycle (i.e., detonation cycle) and thus are not limited to combustion at near constant pressure (e.g., the Brayton Cycle of internal combustion engines) and produce additional work as compared to combustion at near constant pressure. Thus, the thermodynamic efficiencies of the rotating detonation combustor 12 may be approximately 5-7% greater than the thermodynamic efficiencies of an internal combustion engine undergoing deflagration according to the Brayton Cycle.

The detonation wave, once initiated, is typically self-sustaining for as long as the fuel and the oxidizing agent are continuously fed to the combustion chamber 18. As such, the electric machine 30 being configured to convert electrical energy to rotational motion of the shaft 22 assists in maintaining the self-sustaining detonation wave even when the electric machine 30 is primarily being used to convert rotational motion of the shaft 22 to electrical energy. More specifically, the electric machine 30 may convert electrical energy to rotational motion of the shaft 22, thus supplementing the flow rate and/or pressure of the oxidizing agent to the combustion chamber 18 and avoiding ending the self-sustaining detonation wave and requiring re-initiation of the detonation wave. The electric machine 30 being configured to convert electrical energy to rotational motion of the shaft 22 also assists in initiation of the detonation wave by supplying compressed oxidizing agent to the combustion chamber 18 before exhaust gas is available to rotate the first turbine wheel 20 and thus rotate the compressor wheel 24.

The electric generator system 10 may be used in a variety of applications. In non-limiting examples, the electric generator system 10 may be used as a range-extender for electric vehicles or hybrid-electric vehicles and machinery, as a back-up power generator such as for a hospital or other building, or as a standalone power generator.

The second turbine wheel 26 and the electric generator 18 may be incorporated into a turbine generator 44. The turbine generator 44 is free of a second compressor wheel. In other words, the turbine generator 44 does not include any compressor wheel. The turbine generator 44 does not need any compressor wheel because the pressure requirements of the compressed oxidizing agent are much less for a rotating detonation combustor 12. Thus, the compressor wheel 24 rotated by the first turbine wheel 20 and the shaft 22 is sufficient to provide adequate pressure and flow rate of compressed oxidizing agent to the rotating detonation combustor 12. Moreover, the turbine generator 44 does not have parasitic losses resulting from using rotational motion to compress oxidizing agent through a second compressor wheel, and also does not have parasitic losses resulting from rotating additional mass resulting from a second compressor wheel. Minimizing parasitic losses from a second compressor wheel increases the efficiency of conversion of rotational motion of the second turbine wheel 26 to electrical energy.

Although not required, as shown in FIGS. 2-5, the electric generator system 10 may further include a heat recuperator 46 configured to extract heat from at least one of the rotating detonation combustor 12 and the exhaust gas. The heat recuperator 46 transfers heat, either directly or indirectly, to the oxidizing agent. Transferring heat to the oxidizing agent increases the temperature of the oxidizing agent (e.g. pre-heats the oxidizing agent) and thus also increases the efficiency of combustion of the fuel. It is to be appreciated that the heat recuperator 46 may be a heat exchanger, such as but not limited to a counter-flow heat exchanger.

The electric generator system 10 may also include a first exhaust channel 48 configured to receive exhaust gas from the rotating detonation combustor 12 and direct exhaust gas to the first turbine wheel 20. The electric generator system 10 may further include a second exhaust channel 50 configured to receive exhaust gas from the first turbine wheel 20 and direct exhaust gas to the second turbine wheel 26. The electric generator system 10 may further include a third exhaust channel 52 configured to receive exhaust gas from the second turbine wheel 26. The heat recuperator 46 may be configured to receive exhaust gas from at least one chosen from the rotating detonation combustor 12, the first turbine wheel 20, the second turbine wheel 26, the first exhaust channel 48, the second exhaust channel 50, and the third exhaust channel 52. In other words, the heat recuperator 46 may be configured to receive exhaust gas from only one of the rotating detonation combustor 12, the first turbine wheel 20, the second turbine wheel 26, the first exhaust channel 48, the second exhaust channel 50, and the third exhaust channel 52, or may be configured to receive exhaust gas from any combination of two or more of the rotating detonation combustor 12, the first turbine wheel 20, the second turbine wheel 26, the first exhaust channel 48, the second exhaust channel 50, and the third exhaust channel 52.

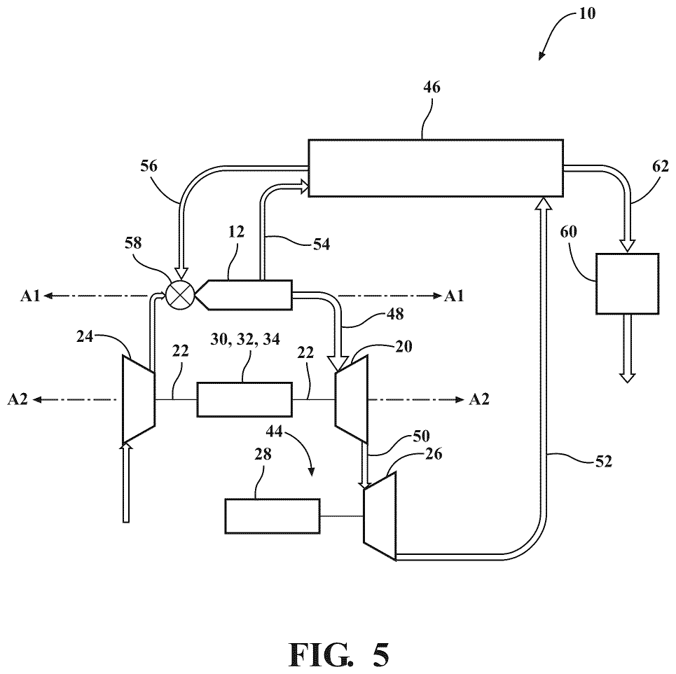

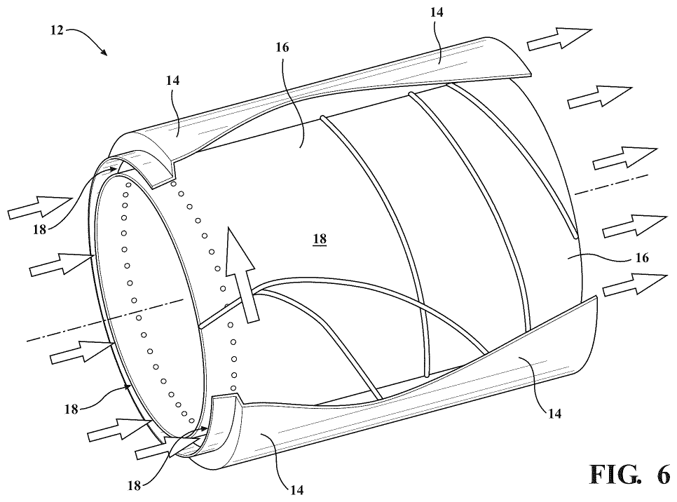

In one embodiment, as shown in FIGS. 4 and 5, the heat recuperator 46 is configured to receive exhaust gas from at least one chosen from the rotating detonation combustor 12 and the first exhaust channel 48, such as shown in FIGS. 4 and 5. In another embodiment, the heat recuperator 46 is configured to receive exhaust gas from at least one chosen from the first turbine wheel 20 and the second exhaust channel 50. In another embodiment, as shown in FIGS. 2, 3, and 5, the heat recuperator 46 is configured to receive exhaust gas from at least one chosen from the second turbine wheel 26 and the third exhaust channel 52.

In one embodiment, the heat recuperator 46 is configured to receive oxidizing agent and directly heat the oxidizing agent. In other words, the oxidizing agent (compressed or uncompressed) flows through the heat recuperator 46. More specifically, as shown in FIG. 2, the heat recuperator 46 may be fluidly disposed between the compressor wheel 24 and the rotating detonation combustor 12 such that the heat recuperator 46 is configured to receive compressed oxidizing agent and directly heat the compressed oxidizing agent. Alternatively, the heat recuperator 46 may be fluidly disposed upstream of the compressor wheel 24 such that the heat recuperator 46 is configured to directly heat uncompressed oxidizing agent.

As shown in FIGS. 4 and 5, the electric generator system 10 may further include an inlet heat exchange channel 54 coupled to the rotating detonation combustor 12 and configured to include an inlet fluid capable of being heated by the rotating detonation combustor 12. The inlet heat exchange channel 54 is configured to direct heated inlet fluid to the heat recuperator 46. The inlet fluid may be a liquid, such as a coolant, or may be a gas, such as an inert gas. The inlet fluid may also serve to lower the temperature of the rotating detonation combustor 12, further increasing the safety of the rotating detonation combustor 12. Although not required, it is also to be appreciated that the inlet heat exchange channel 54 may include both a first line configured to include the inlet fluid capable of being heated by the rotating detonation combustor 12 and direct the heated inlet fluid to the heat recuperator 46, and may also include a second line (e.g., a return line) configured to receive inlet fluid after the inlet fluid has flowed through the first line and the heat recuperator 46 and return the inlet fluid to the rotating detonation combustor 12 to be heated and flowed back through the first line.

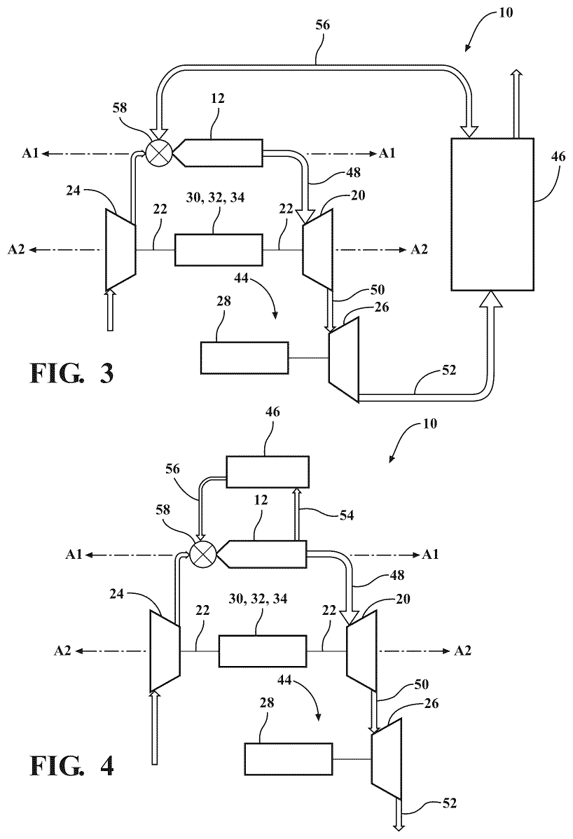

As shown in FIGS. 3, 4, and 5, the electric generator system 10 may further include an outlet heat exchange channel 56 configured to include an outlet fluid capable of being heated by the heat recuperator 46. The electric generator system 10 may further include a heat exchanger 58 configured to receive heated fluid from the outlet heat exchange channel 56 and transfer heat from the heated fluid to the oxidizing agent. More specifically, the heat exchanger 58 may be configured to receive compressed oxidizing agent from the compressor wheel 24 and direct heated, compressed oxidizing agent to the rotating detonation combustor 12.

The outlet fluid may be a liquid, such as a coolant, or may be a gas, such as an inert gas. It is to be appreciated that the outlet fluid and the inlet fluid may be the same type of fluid, or may be different types of fluids. Moreover, although not required, the outlet heat exchange channel 56 may include both a first line configured to include the outlet fluid capable of being heated by the heat recuperator 46 and direct the heated outlet fluid to the heat exchanger 58, and may also include a second line (e.g., a return line) configured to receive outlet fluid after the outlet fluid has flowed through the first line and the heat exchanger 58 and return the outlet fluid to the heat recuperator 46 to be heated and flowed back through the first line.

Moreover, the inlet fluid and the outlet fluid may be the same fluid or may be different fluids. In the embodiments where the inlet fluid and the outlet fluid are the same fluid, the same fluid may be heated by the rotating detonation combustor 12, flow through the first line of the inlet heat exchange channel 54, optionally get further heated by exhaust gas in the heat recuperator 46, flow through the first line of the outlet heat exchange channel 56 to the heat exchanger 58, transfer heat to the oxidizing agent (compressor or uncompressed), and return through the second line of the outlet heat exchange channel 56 and the second line of the inlet heat exchange channel 54 to return to the rotating detonation combustor 12.

The electric generator system 10 may further include a waste heat recovery unit 60 configured to receive exhaust gas and recover heat from the exhaust gas. The exhaust gas received by the waste heat recovery unit 60 may come from anywhere in the electric generator system 10. In a non-limiting example, as shown in FIGS. 2 and 5, the electric generator system 10 may include a fourth exhaust channel 62 configured to receive exhaust gas from the heat recuperator 46, and the waste heat recovery unit 60 may be configured to receive exhaust gas from the fourth exhaust channel 62 and recover heat from the exhaust gas. The waste heat recovery unit 60 increases the efficiency of the electric generator system 10 through recovery of what may be wasted heat.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. An electric generator system for converting rotational motion to electrical energy, said electric generator system comprising:
a rotating detonation combustor extending along an axis, having an outer wall extending along and circumferentially about said axis, and having an inner wall extending along and circumferentially about said axis, with said inner wall spaced radially inward relative to said outer wall such that a combustion chamber is defined between said outer wall and said inner wall, and with said rotating detonation combustor configured to receive a fuel and an oxidizing agent into the combustion chamber and expel exhaust gas from said combustion chamber;
a first turbine wheel in fluid communication with said combustion chamber and configured to rotate upon receiving the exhaust gas;
a shaft rotatable with said first turbine wheel;
a compressor wheel rotatable with said shaft, said compressor wheel in fluid communication with said combustion chamber and configured to deliver compressed oxidizing agent to said combustion chamber;
a second turbine wheel in fluid communication with said first turbine wheel and configured to rotate upon receiving the exhaust gas from said first turbine wheel; and
an electric generator rotatable with said second turbine wheel and configured to convert rotational motion of said second turbine wheel to electrical energy.

2. The electric generator system of claim 1 further comprising an electric machine rotatable with said shaft, with said electric machine configured to convert at least one of rotational motion of said shaft to electrical energy, and electrical energy to rotational motion of said shaft.

3. The electric generator system of claim 1, wherein said second turbine wheel and said electric generator are incorporated into a turbine generator, and wherein said turbine generator is free of a second compressor wheel.

4. The electric generator system of claim 1 further comprising a heat recuperator configured to extract heat from at least one of said rotating detonation combustor and said exhaust gas and transfer heat to said oxidizing agent.

5. The electric generator system of claim 4 further comprising:
a first exhaust channel configured to receive exhaust gas from said rotating detonation combustor and direct exhaust gas to said first turbine wheel,
a second exhaust channel configured to receive exhaust gas from said first turbine wheel and direct exhaust gas to said second turbine wheel, and
a third exhaust channel configured to receive exhaust gas from said second turbine wheel,
wherein said heat recuperator is configured to receive exhaust gas from at least one chosen from said rotating detonation combustor, said first turbine wheel, said second turbine wheel, said first exhaust channel, said second exhaust channel, and said third exhaust channel.

6. The electric generator system of claim 5, wherein said heat recuperator is configured to receive exhaust gas from at least one chosen from said rotating detonation combustor and said first exhaust channel.

7. The electric generator system of claim 5, wherein said heat recuperator is configured to receive exhaust gas from at least one chosen from said first turbine wheel and said second exhaust channel.

8. The electric generator system of claim 5, wherein said heat recuperator is configured to receive exhaust gas from at least one chosen from said second turbine wheel and said third exhaust channel.

9. The electric generator system of claim 4 further comprising an inlet heat exchange channel coupled to said rotating detonation combustor and configured to include an inlet fluid capable of being heated by said rotating detonation combustor, wherein said inlet heat exchange channel is configured to direct heated inlet fluid to said heat recuperator.

10. The electric generator system of claim 4, wherein said heat recuperator is configured to receive oxidizing agent and directly heat said oxidizing agent.

11. The electric generator system of claim 4, wherein said heat recuperator is fluidly disposed between said compressor wheel and said rotating detonation combustor such that said heat recuperator is configured to receive compressed oxidizing agent and directly heat to said compressed oxidizing agent.

12. The electric generator system of claim 4, wherein said electric generator system further comprises:
an outlet heat exchange channel configured to include an outlet fluid capable of being heated by said heat recuperator; and
a heat exchanger configured to receive heated fluid from said outlet heat exchange channel and transfer heat from said heated fluid to said oxidizing agent.

13. The electric generator system of claim 12, wherein said heat exchanger is configured to receive compressed oxidizing agent from said compressor and direct heated, compressed oxidizing agent to said rotating detonation combustor.

14. The electric generator system of claim 1 further comprising a waste heat recovery unit configured to receive exhaust gas and recover heat from said exhaust gas.

15. The electric generator system of claim 4 further comprising:
a fourth exhaust channel configured to receive exhaust gas from said heat recuperator, and
a waste heat recovery unit configured to receive exhaust gas from said fourth exhaust channel and recover heat from said exhaust gas.

16. The electric generator system of claim 2, wherein said electric machine is configured to both convert rotational motion of said shaft to electrical energy, and convert electrical energy to rotational motion of said shaft.

17. The electric generator system of claim 2, wherein said electric machine is configured to control a mass flow rate of said oxidizing agent to said rotating detonation combustor.

18. The electric generator system of claim 17, wherein said electric machine is configured to control said mass flow rate of said oxidizing agent to said rotating detonation combustor such that said rotating detonation combustor operates with a lean fuel to oxidizing agent ratio.

19. The electric generator system of claim 2, wherein said electric machine is disposed between said turbine wheel and said compressor wheel.

20. The electric generator system of claim 1 further comprising:
a first exhaust channel configured to receive exhaust gas from said rotating detonation combustor and direct exhaust gas to said first turbine wheel,
a second exhaust channel configured to receive exhaust gas from said first turbine wheel and direct exhaust gas to said second turbine wheel,
a third exhaust channel configured to receive exhaust gas from said second turbine wheel, and
a heat recuperator fluidly disposed between said compressor wheel and said rotating detonation combustor such that said heat recuperator is configured to receive compressed oxidizing agent and direct heat to said compressed oxidizing agent,
wherein said heat recuperator is configured to receive exhaust gas from at least two chosen from said rotating detonation combustor, said first turbine wheel, said second turbine wheel, said first exhaust channel, said second exhaust channel, and said third exhaust channel and transfer heat to said compressed oxidizing agent.
